(19) United States
(12) Patent Application Publication
(10) Pub. No.: US 2014/0343945 A1
(43) Pub. Date: Nov. 20, 2014

(54) METHOD OF VISUAL VOICE RECOGNITION BY FOLLOWING-UP THE LOCAL DEFORMATIONS OF A SET OF POINTS OF INTEREST OF THE SPEAKER'S MOUTH

(71) Applicant: PARROT, Paris (FR)

(72) Inventors: Eric Benhaim, Ermont (FR); Hichem Sahbi, Paris (FR)

(73) Assignee: PARROT, Paris (FR)

(21) Appl. No.: 14/273,273

(22) Filed: May 8, 2014

(30) Foreign Application Priority Data
May 15, 2013 (FR) 1354335

(51) Int. Cl. G10L 15/18; G10L 21/10

(52) U.S. Cl. CPC G10L 15/18; G10L 21/10; G10L 2019/0001
USPC 704/257

(57) ABSTRACT

The method comprises steps of: a) for each point of interest of each image, calculating a local gradient descriptor and a local movement descriptor; b) forming microstructures of n points of interest, each defined by a tuple of order n, with n≧1; c) determining, for each tuple of a vector of structured visual characteristics (d₀ . . . d₃ . . . ) based on the local descriptors; d) for each tuple, mapping this vector by a classification algorithm selecting a single codeword among a set of codewords forming a codebook (CB); e) generating an ordered time series of the codewords (a₀ . . . a₃ . . . ) for the successive images of the video sequence; and f) measuring, by means of a function of the String Kernel type, the similarity of the time series of codewords with another time series of codewords coming from another speaker.

The invention relates to the visual voice-activity recognition or VSR (Visual Speech Recognition), a technique also known as “lip reading”, consisting in operating the automatic recognition of the spoken language by analysis of a video sequence formed of a succession of images of the mouth region of a speaker.

The region of study, hereinafter called the “mouth region”, comprises the lips and their immediate vicinity, and may possibly be extended to cover a wider area of the face, including for example the jaw and the cheeks.

A possible application of this technique, which is of course not limitative, is the voice recognition by “hands-free” telephone systems used in a very noisy environment, as in the passenger compartment of an automotive vehicle.

Such difficulty linked to the surrounding noise is particularly restricting in this application, due to the great distance between the microphone (placed at the dashboard or in an upper corner of the passenger compartment roof) and the speaker (whose remoteness is constrained by the driving position), which leads to the picking up of a relatively high noise level and consequently a difficult extraction of the useful signal embedded in the noise. Moreover, the very noisy environment typical of automotive vehicles has characteristics that evolve unpredictably as a function of the driving conditions (rolling on uneven or cobbled road surfaces, car radio in operation, etc.), which are very complex to take into account by the soundproofing algorithms based on the analysis of the signal picked-up by a microphone.

Therefore, a need exists for systems making it possible to recognize with a high degree of certainty, for example the digits of a phone number said by the speaker, in circumstances where the recognition by acoustic means cannot be correctly implemented any more due to a too degraded signal/noise ratio. Moreover, it has been observed that sounds such as /b/, /v/, /n/ or /m/ are often open to misinterpretation in the audio domain, whereas there is no ambiguity in the visual domain, so that the association of acoustic recognition means and visual recognition means may be of such a nature to provide a substantial improvement of the performances in the noisy environments where the conventional only-audio systems lack robustness.

However, the performances of the automatic lip-reading systems that may have been proposed until now remain insufficient, with a major difficulty residing in the extraction of visual characteristics that are really relevant for discriminating the different words or fractions of words said by the speaker. Moreover, the inherent variability between speakers that exists in the appearance and the movement of the lips provides the present systems with very bad performances.

Besides, the visual voice-activity recognition systems proposed until now implement techniques of artificial intelligence requiring very significant software and hardware means, hardly conceivable within the framework of very widely distributed products with very strict cost constraints, whether they are systems incorporated to the vehicle or accessories in the form of a removable box integrating all the signal processing components and functions for the phone communication.

Therefore, there still exists a real need to have visual voice recognition algorithms that are both robust and calculation-resource saving for their implementation, especially when the matter is to be able to perform this voice recognition “on the fly”, almost in real time.

The article of Ju et al. “Speaker Dependent Visual Speech Recognition by Symbol and Rear Value Assignment”, Robot Intelligence Technology and Applications 2012 Advances in Intelligent Systems and Computing, Springer, pp 1015-1022, January 2013, pp. 1015-1022, describes such an algorithm of automatic speech recognition by VSR analysis of a video sequence, but whose efficiency remains concretely limited, insofar as it does not combine the local visual voice characteristics with the spatial relation between points of interest.

Other aspects of these algorithms are developed in the following articles:
Navneet et al. “Human Detection Using Oriented Histograms of Flow and Appearance”, Proceedings of the European Conference on Computer Vision, Springer, pp. 428-441, May 2006;
Sivic et al. “Video Google: A Text Retrieval Approach to Object Matching in Videos”, Proceedings of the 8th IEEE International Conference on Computer Vision, pp. 1470-1477, October 2003;
Zheng et al. “Effective and efficient Object-based Image Retrieval Using Visual Phrases”, Proceedings of the 14th Annual ACM International Conference on Multimedia, pp. 77-80, January 2006;
Zavesky “LipActs: Efficient Representations for Visual Speakers”, 2011 IEEE International Conference on Multimedia and Expo, pp. 1-4; July 2011;
Yao et al. “Grouplet: A structured image Representation for Recognising Human and Object Interactions”, 2010 IEEE Conference on Computer Vision and Pattern Recognition, pp. 9-16, June 2010;
Zhang et al. “Generating Descriptive Visual Words and Visual Phrases for Large-Scale Image Applications”, IEEE Transactions on Image Processing, Vol. 20, No. 9, pp 2664-2667, September 2011;
Zheng et al. “Visual Synset: Towards a Higher-Level Visual representation”, 2008 IEEE Conference on Computer Vision and Pattern Recognition, pp. 9-16, June 2008.

The object of the invention is to provide the existing techniques of visual voice recognition with a number of processing improvements and simplifications, making it possible both to improve the whole performances (in particular with an increased robustness and a lesser variability between speakers) and to reduce the calculation complexity, so as to make the recognition compatible with the means existing in widely distributed devices.

According to a first aspect, the invention proposes a new concept of structured visual characteristics.

They are characteristics about the way to describe the vicinity of a point chosen on the image of the speaker's mouth, hereinafter referred to as “point of interest” (a notion that is also known as “landmark” or “point of reference”). These structured characteristics (also known as features in the scientific community) are generally described by characteristic vectors or “feature vectors” of great size, which are complex to process. The invention proposes to apply to these vectors a transformation that makes it possible both to simplify the expression thereof and to efficiency encode the variability induced by the visual language, allowing a much simpler analysis, and yet as efficient, without critical information loss and keeping the time consistency of the speech.

According to a second aspect, complementary to the preceding one, the invention proposes a new learning procedure based on a particular strategy of combination of the structure characteristics. The matter is to form sets of one or several points of interest grouped into “tuples”, wherein a tuple can be a singleton (tuple of order 1), a pair (tuple of order 2), a triplet (tuple of order 3), etc. The learning will consist in extracting among all the possible tuples of order 1 to N (N being generally limited to N=3 or N=4) a selection of the most relevant tuples and to perform the visual voice recognition on this reduced sub-set of tuples.

For the construction of the tuples, the invention proposes to implement a principle of aggregation, starting from singletons (isolated points of interest), to which are associated other singletons to form pairs that will be subsequently subjected to a first selection of the most relevant tuples, guided in particular by the maximization of performances of a Support Vector Machine (SVM) via a Multi-Kernel Learning MKL, to combine the tuples and their associated characteristics.

The aggregation is continued by association of singletons to these selected pairs, to form triplets, which will be too subjected to a selection, and so on. At each group of higher-order tuples newly created is applied a selection criterion for keeping among them only the most efficient tuples within the meaning of visual voice recognition, i.e., concretely, those which have the most significant deformations through the successive images of the video sequence (starting from the hypothesis that the tuples that move the most will be the most discriminant for the visual voice recognition). More precisely, according to the above-mentioned first aspect, the invention proposes a method comprising the following steps:
a) for each point of interest of each image, calculating:
   a local gradient descriptor, function of an estimation of the distribution of the oriented gradients, and
   a local movement descriptor, function of an estimation of the oriented optical flows between successive images,
   said descriptors being calculated between successive images in the vicinity of the considered point of interest;
b) forming microstructures of n points of interest, each defined by a tuple of order n, with n≧1;
c) determining, for each tuple of step b), a vector of structured visual characteristics encoding the local deformations as well the spatial relation between the underlying points of interest, this vector being formed based on said local gradient and movement descriptors of the points of interest of the tuple;
d) for each tuple, mapping the vector determined at step c) into a corresponding codeword, by application of a classification algorithm adapted to select a single codeword among a finite set of codewords forming a codebook;
e) generating an ordered time series of the codewords determined at step d) for each tuple, for the successive images of the video sequence;
f) for each tuple, analyzing the time series of codewords generated at step e), by measuring the similarity with another time series of codewords coming from another speaker.

The measurement of similarity of step f) is advantageously implemented by a function of the String Kernel type, adapted to:
f1) recognize matching sub-sequences of codewords of predetermined size present in the generated time series and in the other time series, respectively, a potential discordance of a predetermined size being tolerated, and
f2) calculate the rates of occurrence of said sub-sequences of codewords, so as to map, for each tuple, the time series of codewords into fixed-length representations of string kernels.

The local gradient descriptor is preferably a descriptor of the Histogram of the Oriented Gradients HOG type, and the local movement descriptor is a descriptor of the Histogram of the Optical Flows HOF type.

The classification algorithm of step d) may be a non-supervised classification algorithm of the k-means algorithm type.

The above-mentioned method may in particular be applied for:
g) using the results of the measurement of similarity of step f) for a learning by a supervised classification algorithm of the Support Vector Machine SVM type.

According to the above-mentioned second aspect, the invention proposes a method comprising the following steps:
a) forming a starting set of microstructures of n points of interest, each defined by a tuple of order n, with 1≦n≦N;
b) determining, for each tuple of step a), associated structured visual characteristics, based on local gradient and/or movement descriptors of the points of interest of the tuple;
c) iteratively searching for and selecting the most discriminant tuples by:
   c1) applying to the set of tuples an algorithm adapted to consider combinations of tuples with their associated structured characteristics and determining, for each tuple of the combination, a corresponding relevancy score;
   c2) extracting, from the set of tuples considered at step c1), a sub-set of tuples producing the highest relevancy scores;
   c3) aggregating additional tuples of order 1 to the tuples of the sub-set extracted at step c2), to obtain a new set of tuples of higher order;
   c4) determining structured visual characteristics associated to each aggregated tuple formed at step c3);
   c5) selecting, in said new set of higher order, a new sub-set of most discriminant tuples; and
   c6) reiterating steps c1) to c5) up to a maximal order N; and
d) executing a visual language recognition algorithm based on the tuples selected at step c).

Advantageously, the algorithm of step c1) is an algorithm of the Multi-Kernel Learning MKL type, the combinations of step c1) are linear combinations of tuples, with, for each tuple, an optimum weighting, calculated by the MKL algorithm, of its contribution in the combination, and the sub-set of tuples extracted at step c2) is that of the tuples having the highest weights.

In a first embodiment of the above-mentioned method:
steps c3) to c5) implement an algorithm adapted to:
   evaluate the velocity, over a succession of images, of the points of interest of the considered tuples, and
   calculate a distance between the additional tuples of step c3) and the tuples of the sub-set extracted at step c2); and
the sub-set of most discriminant tuples extracted at step c5) is that of the tuples satisfying a Variance Maximization Criterion VMC.

In a second, alternative, embodiment of this method:
steps c3) to c5) implement an algorithm of the Multi-Kernel Learning MKL type adapted to:
   form linear combinations of tuples, and
   calculate for each tuple an optimal weighting of its contribution in the combination; and
the sub-set of most discriminant tuples extracted at step c5) is that of the tuples having the highest weights.

An exemplary embodiment of the device of the invention will now be described, with reference to the appended drawings in which same reference numbers designate identical or functionally similar elements throughout the figures.

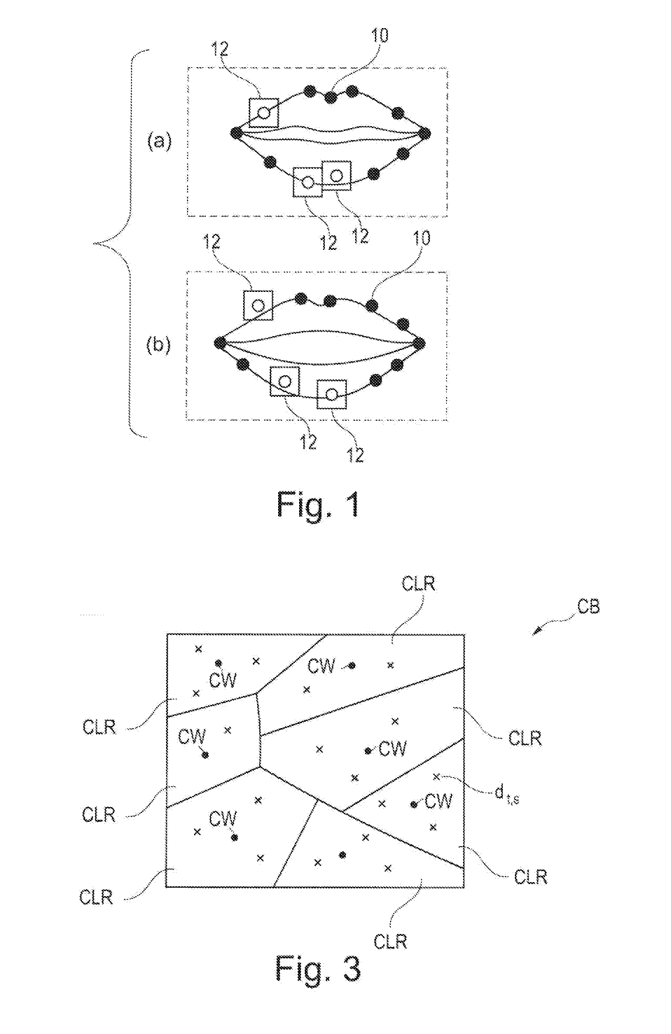

FIGS. 1a and 1b show two successive images of the mouth of a speaker, showing the variations of position of the various points of interest and the deformation of a triplet of these points from one image to the following one.

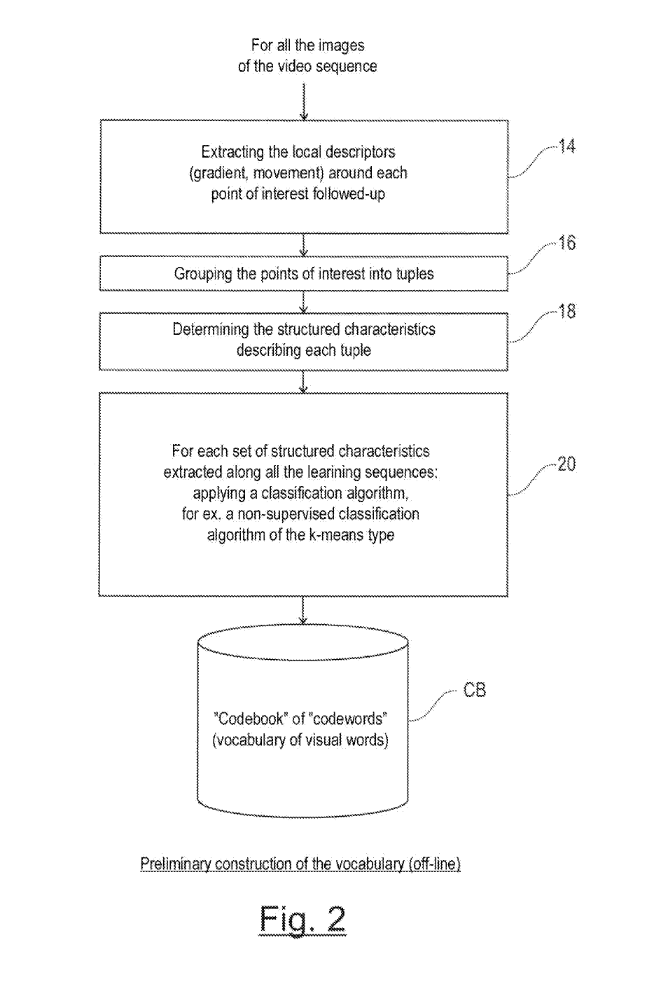

FIG. 2 illustrates the main steps of the processing chain intended for the preliminary construction of the visual vocabulary.

FIG. 3 graphically illustrates the decoding of the codewords by application of a classification algorithm, the corresponding codebook being herein represented for the need of explanation in a two-dimensional space.

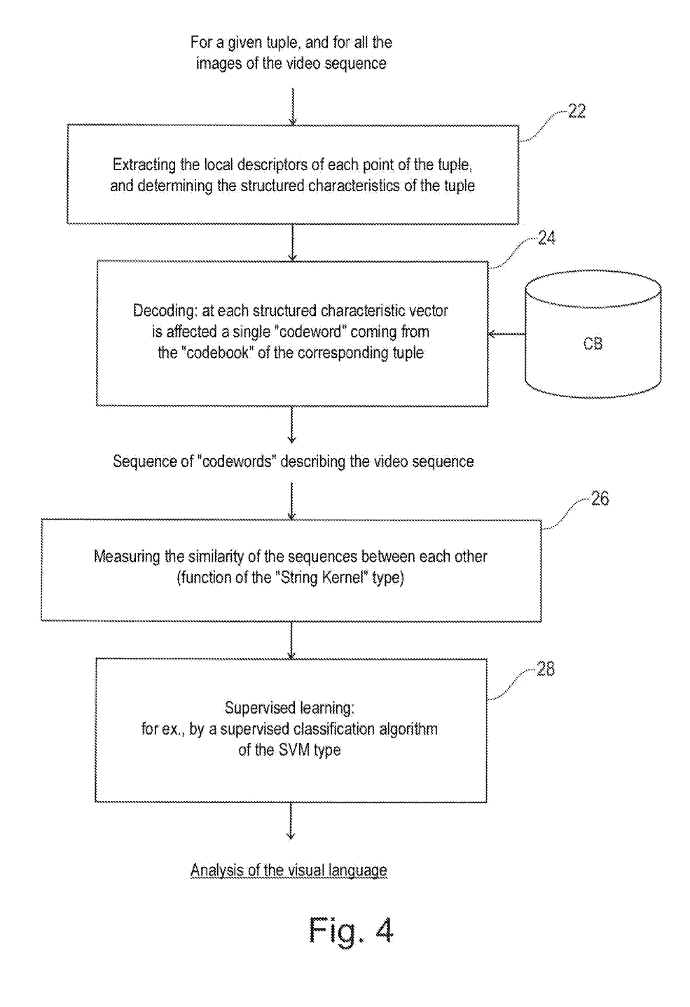

FIG. 4 schematically illustrates the different steps of the visual language analysis implementing the teachings of the first aspect of the invention.

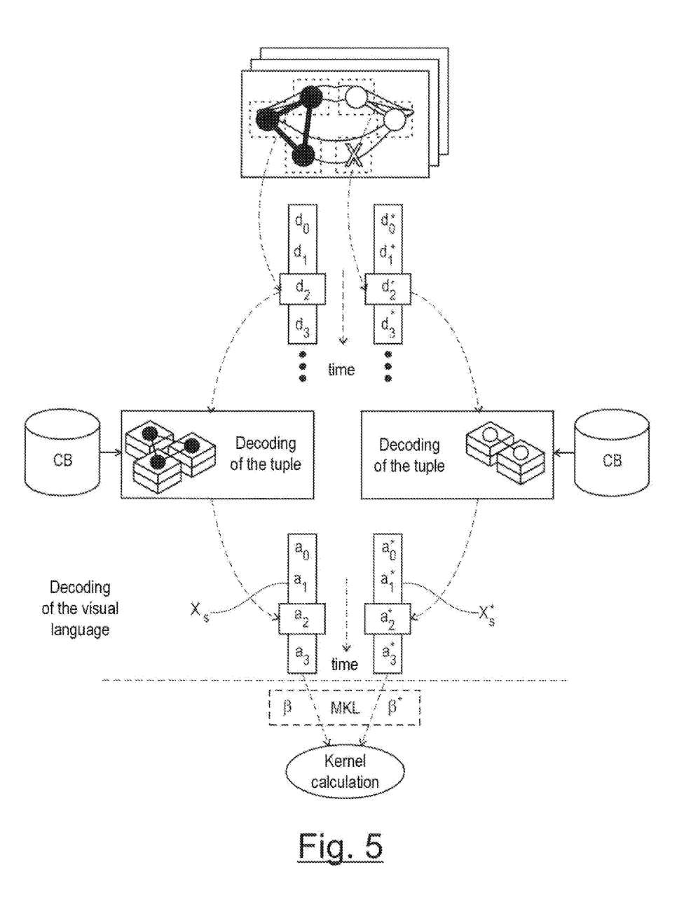

FIG. 5 illustrates the way to proceed to the decoding of a tuple with determination of the structured characteristics in accordance to the technique of the invention, according to the first aspect of the latter.

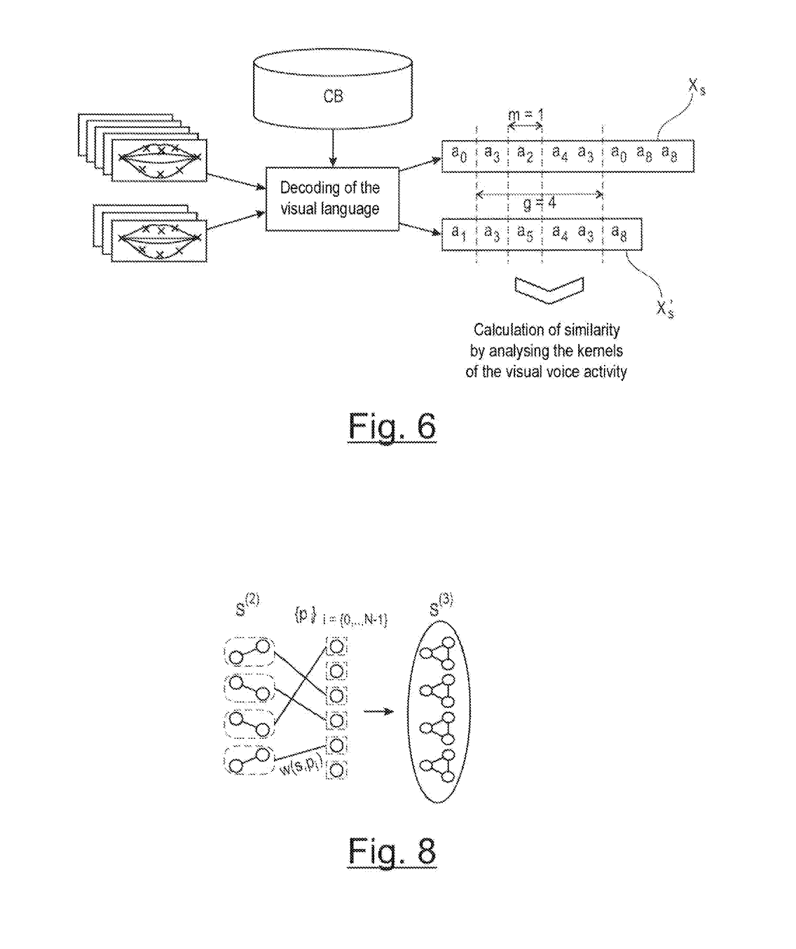

FIG. 6 illustrates the production, by decoding of the visual language, of time series of visual characters liable to be subjected to a measurement of similarity, in particular for purposes of learning and recognition.

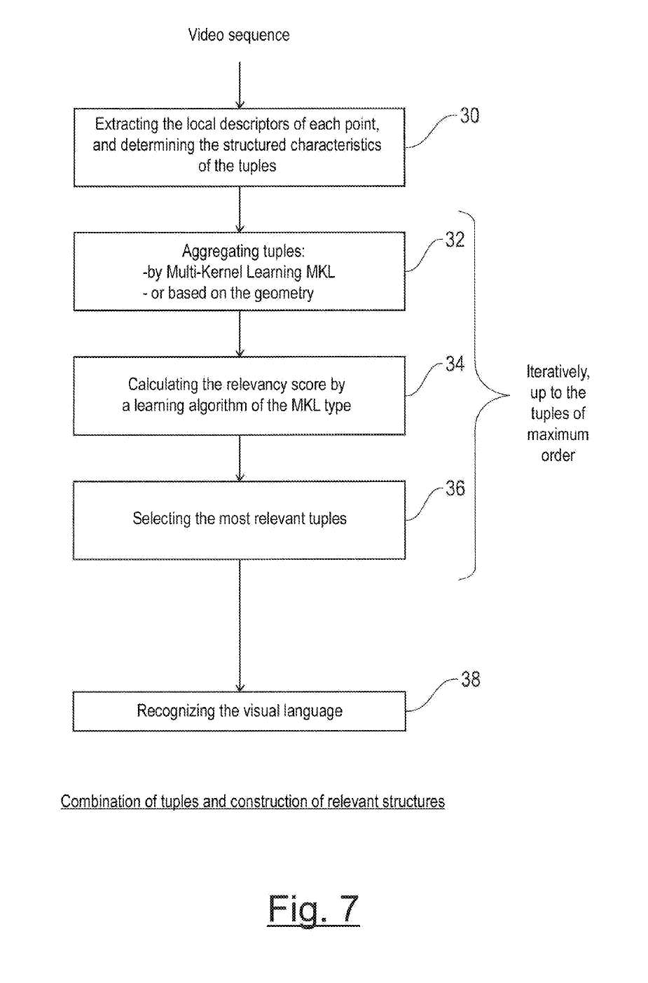

FIG. 7 is an flowchart describing the main steps of the processing chain operating the combination of the tuples and the selection of the most relevant structures, with implementation of the invention according to the second aspect of the latter.

FIG. 8 illustrates the aggregation process for constructing and selecting tuples of increasing order, according to the second aspect of the invention.

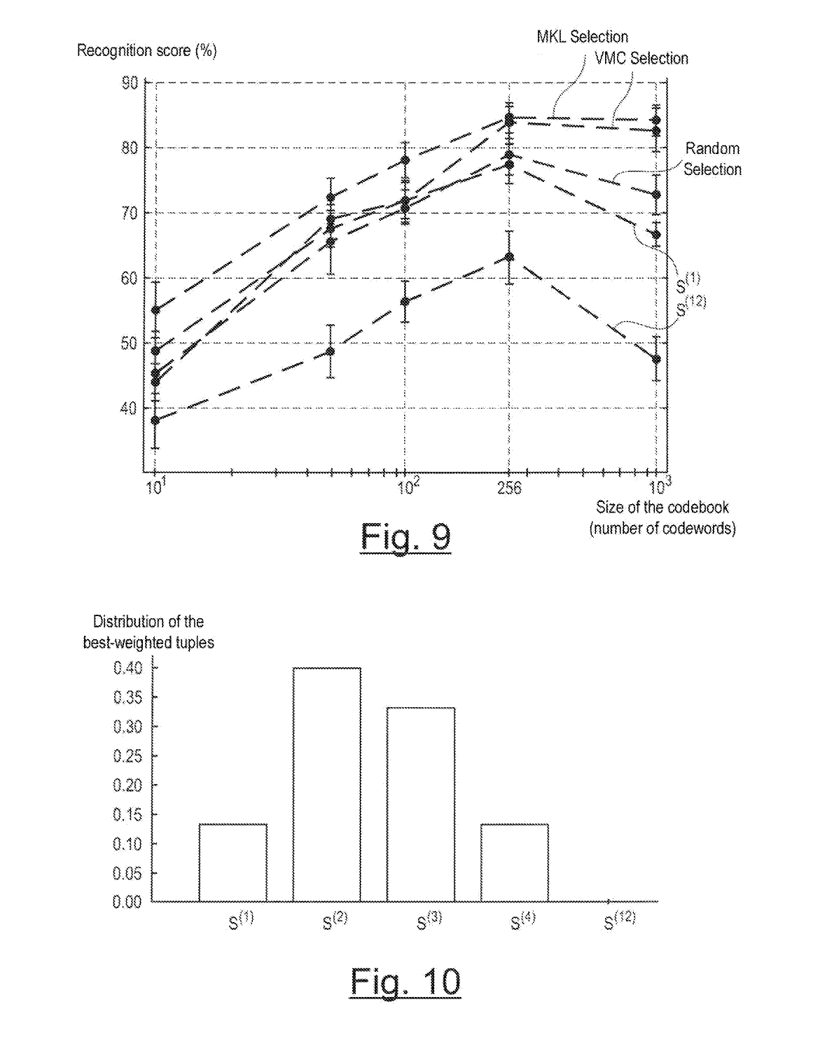

FIG. 9 is a graphical representation showing the performances of the invention as a function of the different strategies of selection of the tuples and of size of the codebook.

FIG. 10 illustrates the distribution of the tuple orders of the structured characteristics selected following the aggregation process according to the second aspect of the present invention.

In FIG. 1 are shown two successive images of the mouth of a speaker, taken from a video sequence during which the latter articulates a word to be recognized, for example a digit of a phone number said by this speaker. In a manner known per se, the analysis of the movement of the mouth is operated by detection and follow-up of a certain number of points of interest 10, in this example twelve in number.

### General Architecture of the Method of the Invention

The follow-up of these points of interest implements appearance and movement components. For each point followed-up, these two components are characterized, in a manner also known per se, by spatial histograms of oriented gradients or HOG, on the one hand, and spatial histograms of oriented optical flows HOF, on the other hand, in the near vicinity of the considered point.

For a more detailed description of these HOG and HOF histograms, reference may be made to, respectively:
[1] N. Dalal and B. Triggs, “Histograms of Oriented Gradients for Human Detection”, Computer Vision and Pattern Recognition, 2005. CVPR 2005. IEEE Computer Society Conference on. IEEE, 2005, Vol. 1, pp. 886-893, and
[2] N. Dalal, B. Triggs and C. Schmid, “Human Detection Using Oriented Histograms of Flow and Appearance”, Computer Vision-ECCV 2006, pp. 428-441, 2006.

The choice of a HOG descriptor comes from the fact that the local appearance and shape of an object in an image can be described by the distribution of the directions of the most significant outlines. The implementation may be made simply by dividing the image into small-size adjacent regions or cells, and by compiling for each cell the histogram of the directions of the gradient or of the orientations of the outlines for the pixels inside this cell. The combination of the histograms then forms the HOG descriptors.

The HOF descriptors are formed in a similar way based on the estimation of the optical flow between two successive images, in a manner also known per se.

Each followed-up point of interest p_{t,i} will thus be described by a visual characteristic vector f_{t,i} obtained by concatenating the normalized HOG and HOF histograms extracted for this point i, at the instant t of a video sequence of speech:

f_{t,i}=[HOGₚ_{_{t,i}},HOFₚ_{_{t,i}}]

Characteristically, according to a first aspect of the present invention, each visual characteristic vector of the video sequence will be subjected to a transformation for simplifying the expression thereof while efficiently encoding the variability induced by the visual language, to obtain an ordered sequence of “words” or codewords of a very restricted visual vocabulary, describing this video sequence. It will then be possible, based on these codeword sequences, to measure in a simple way the similarity of sequences between each other, for example by a function of the String Kernel type.

According to a second characteristic aspect, the present invention proposes to follow-up not (or not only) the isolated points of interest, but combinations of one or several of these points, forming microstructures called “tuples”, for example as illustrated in FIG. 1 a triplet 12 (tuple of order 3) whose deformations will be analyzed and followed-up to allow the voice recognition.

This approach has the advantage to combine both the local visual characteristics (those of the points of interest) and the spatial relations between the points of the considered tuple (i.e. the deformation of the figure formed by the pair of triplets, of quadruplets . . . of points of interest). The way to construct these tuples and to select the most discriminant ones for the visual voice analysis will be described hereinafter, in relation with FIGS. 7 and 8.

### Preliminary Construction of the Visual Vocabulary

FIG. 2 illustrates the main steps of the processing chain intended for the preliminary construction of the visual vocabulary, based on a learning database of video sequences picked-up for different speakers.

The first step consists, for all the images of a video sequence and for each point of interest followed-up, to extract the local gradient and movement descriptors (block 14) by calculation of the HOG and HOF histograms and concatenation, as indicated hereinabove.

The points of interest are then grouped into tuples (block 16), and structured characteristics are then determined to describe each tuple specifically, from the local descriptors of each point of interest of the tuple concerned.

These operations are reiterated for all the video sequences of the learning database, and a classification algorithm is applied (block 20), for example a non-supervised classification algorithm of the k-means type allowing to define a vocabulary of visual words, that will be called hereinafter by their usual name of “codewords”, for consistency with the terminology used in the different scientific publications and to avoid any ambiguity. These visual words form together a vocabulary called “codebook”, formed of K codewords.

FIG. 3 schematically shows such a codebook CB, divided into a finite number of clusters CLR each characterized by a codeword CW defining the center of each cluster; the crosses correspond to the different characteristic vectors d_{s,t} affected to the index of the nearest cluster, and thus to the codeword characterizing this cluster.

### Technique of Analysis of the Visual Language According to the First Aspect of the Invention

FIG. 4 schematically illustrates the different steps of the visual language analysis implementing the teachings of the first aspect of the invention For a given tuple, and for all the images of the video sequence, the algorithm proceeds to the extraction the local HOG and HOF descriptors of each point of interest of the tuple, and determines the vector d_{t,s} of structured characteristics of the tuple (block 22). Let's call n the order of the tuple (for example, n=3 for a triplet of points of interest), the description vector of the tuple s is formed by the concatenation of the n vectors of local descriptors f_{t,i}=[HOGₚ_{_{t,i}}, HOFₚ_{_{t,i}}], i.e. d_{t,s}=[f_{t,i}]_{iεs} (for a triplet of points of interest, the description vector is thus a concatenation of three vectors f_{t,i}).

It is important to note that, by construction, each characteristic vector d_{t,s} encodes as well the local visual characteristics (i.e. those of each of the points of interest) as the spatial relations between the points of the face (hence, those which are specific to the tuple as such).

The following step is a decoding step (block 24), which will be described in more detail in particular in relation with FIG. 5.

Essentially, for a tuple s of the set of tuples, we consider the union Dₛ of all the structured characteristic vectors extracted from different frames of the learning video sequences at the position indices s. In order to associate a single codeword to a characteristic vector d_{t,s}, the algorithm partitions Dₛ into k partitions or clusters (within the meaning of the data partitioning, or data clustering, technique as a statistical method of data analysis).

It may notably be used for that purpose a non-supervised classification algorithm of the k-mean algorithm type, which consists in searching in a space of data for partitions gathering in a same class the neighbour points (within the meaning of the Euclidian distance), so that each data belongs to the cluster having the nearest mean. The details of this technique of analysis may be found, in particular, in:
[3] S. P. Lloyd “Least squares quantization in PCM”, IEEE Transactions on Information Theory, 28 (2): 129-137, 1982.

The vector d_{t,s} is then affected to the index of the nearest cluster, as schematically illustrated in the above-described FIG. 3, which schematically shows the codebook CB, divided into a finite number of clusters CLR each characterized by a codeword CW. The decoding consists in affecting each characteristic vector d_{t,s} to the index of the nearest cluster CLR, and thus to the codeword CW characterizing this cluster.

The result of the decoding of step 24, applied to all the images of the video sequence, produces an ordered sequence of codewords, denoted Xₛ, describing this video sequence.

It will then be possible, based on these sequences of codewords, to perform in a simple manner a measurement of similarity of the sequences between each other (block 26), for example by a function of the String Kernel type, as will be explained hereinafter in relation with FIG. 6.

The application of this technique to all the learning video sequences (block 28) may be used for the implementation of a supervised learning, for example by means of a supervised classification algorithm of the Support Vector Machine SVM type.

For a more detailed description of such SVM algorithms, reference may be made to:
[4] H. Drucker, C. J. C. Burges, L. Kaufman, A. Smola and V. Vapnik “Support Vector Regression Machines”, Advances in Neural Information Processing Systems 9, pages 155-161, MIT Press, 1997.

FIG. 5 illustrates more precisely the way to proceed to the decoding of step 24, with determination for each tuple of the structured characteristics by the technique of the invention, according to the first aspect of the latter. This visual language decoding operation is performed successively for each image of the video sequence, and for each tuple of each image. FIG. 5 illustrates such a decoding performed for two tuples of the image (a triplet and a pair) but of course this decoding is operated for all the tuple orders, so as to obtain for each one a corresponding sequence Xₛ of codewords.

The local descriptors f_{t,i} of each point of interest of each tuple are calculated as indicated hereinabove (based on the HOG and HOG histograms), then concatenated to give the descriptor dₜ of each tuple, so as to produce a corresponding vector of structured visual characteristics. A sequence of vectors d_{t,s} of great size describing the morphology of the tuple s and the deformations thereof in the successive images of the video sequence is thus obtained.

Each tuple is then processed by a tuple decoder allowing to map the great size-vector d_{t,s} of the considered image into a single corresponding codeword belonging to the finite set of codewords of the codebook CB. The result is a time sequence of codewords a₀ . . . a₃ . . . homologous to the sequence d₀ . . . d₃ . . . of the visual characteristic vectors relating to the same sequence. These simplified time sequences a₀ . . . a₃ . . . are simple series of integers, each element of the series being simply the index a of the cluster identifying the codeword in the codebook. For example, with a codebook of 10 codewords, the index a may be represented by a simple digit comprised between 0 and 9 and with a codebook of 256 codewords, by a simple byte.

The following step will consist in applying to the tuples an algorithm of the Multiple Kernel Learning MKL type, consisting in establishing a linear combination of several tuples with attribution of a respective weight β to each one. For a more detailed description of these MKL algorithms, reference may be made in particular to:
[5] A. Zien and C. S. Hong, “Multiclass Multiple Kernel Learning”, Proceedings of the 24th International Conference on Machine Learning, ACM, 2007, pp. 1191-1198.

More particularly, FIG. 6 illustrates the use of time series of visual characteristics obtained by the just exposed visual language decoding, for a measurement of similarity between sequences, in particular for purposes of learning and recognition.

According to a characteristic aspect of the invention, it is proposed to adapt and apply the mechanism of the functions of the String Kernel type for measuring the similarity between these visual language sequences and encoding the dynamism inherent to the continuous speech.

For a more thorough study of these String Kernel functions, reference may be made in particular to:
[6] C. Leslie, E. Eskin and W. S. Noble, “The Spectrum Kernel: A String Kernel for SVM Protein Classification”, Proceedings of the Pacific Symposium on Biocomputing, Hawaii, USA, 2002, Vol. 7, pp. 566-575, and
[7] S. V. N. Vishwanathan and A. J. Smola, “Fast Kernels for String and Tree Matching”, Kernel Methods in Computational Biology, pp. 113-130, 2004.

The decoding of a sequence of video images, operated as described in FIG. 5, produces a time sequence of codewords Xₛ for each tuple s of the set of tuples followed-up in the image.

The principle consists in constructing a mapping function allowing to compare not the rate of the codewords representing the visual frequency, but the rate of common sub-sequences of length g (searching for g adjacent codewords of the same codebook), so as not to lose the spatial information of the sequence. The time consistency of the continuous speech can hence be kept. A potential discordance of size m will be tolerated in the sub-sequences.

For example, in the example of FIG. 6, it can be observed between the sequences Xₛ and X′ₛ of codewords a sub-sequence of g=4 adjacent characters, with a discordance of m=1 character.

The algorithm determines the rate of occurrence of the sub-sequences common to the two sequences Xₛ and X′ₛ of codewords, giving a set of measurements accounting the set of all the sequences of length g that are different from each other by a maximum of m characters. For each tuple, the time series of codewords can then be mapped into fixed-length representations of string kernels, this mapping function hence allowing to solve the problem of classification of variable-size sequences of the visual language.

### Technique of Construction and Selection of the Tuples According to the Second Aspect of the Invention

FIG. 7 is a flow diagram describing the main steps of the processing chain operating the combination of the tuples and the selection of the most relevant structures, according to a second aspect of the invention.

The first step consists in extracting the local descriptors of each point, and determining the structured characteristics of the tuples (block 30, similar to block 22 described for FIG. 4).

The following step, characteristic of the invention according to the second aspect thereof, consists in constructing tuples based on singletons and by progressive aggregation (block 32). It will be seen that this aggregation can be performed according to two different possible strategies lying i) on a common principle of aggregation and ii) either a geometric criterion, or a multi-kernel learning MKL procedure.

To characterize the variability of the movement of the lips, due to different articulations and to the different classes of the visual speech, it is proposed to perform a selection by observing the statistics of velocity of the points of interest of the face around the lips. This method of selection begins by the smallest order (i.e., among the set of tuples, the singletons) and follows an incremental “gluttonous approach” (greedy algorithm) to form new tuples of higher order by aggregating an additional tuple to the tuples of the current selection of tuples, and by operating a new selection based on a relevancy score calculation (block 34), for example by a Variance Maximization Criterion VMC, as will be described hereinafter, in particular in relation with FIG. 8.

The most relevant tuples are then iteratively selected (block 36). Once the maximum order (for example, the order 4, which is considered as an upper limit for a tuple size) is reached, it will be considered that it is sufficient to use the thus-selected tuples, and not all the possible tuples, for any operation of recognition of the visual language (block 38).

FIG. 8 illustrates the just-mentioned aggregation process, in a phase in which a singleton is added to the pairs that have already been selected to form a set of triplets and to select in these triplets the most relevant among the set of tuples already formed (singletons, pairs and triplets), etc. In the case of an aggregation of tuples based on a geometric strategy, the selection of the most relevant tuples is advantageously made by a VMC (Variance Maximization Criterion) strategy, consisting in calculating a distance, such as a Hausdorff distance, on different images of a video sequence, between i) the points of interest linked to the tuples of the selection S⁽ⁿ⁾ and ii) the points of interest of the singletons of the set S⁽¹⁾, by selecting the tuples of S⁽ⁿ⁺¹⁾ producing the best affectation between the tuples of S⁽ⁿ⁾ and the tuples of S⁽¹⁾, this selection being performed for example by application of a Kuhn-Mundres algorithm or “Hungarian algorithm”. This selection procedure is repeated for increasing values of n (in practice, n=1 . . . 4) and at the end of the procedure, only the tuples having the highest variances are kept for performing the visual language recognition.

As a variant, the tuple aggregation may be no longer based on the geometry but assisted by an algorithm of the Multiple Kernel Learning MKL type, with a linear combination of several tuples with attribution of a weight β to each one (reference may be made to the above-mentioned article [5] for more details on these MKL algorithms). The learning begins by a linear combination of elementary singletons, the algorithm then selecting the singletons having obtained the highest MKL weights. This procedure is repeated for increasing values of n, using the kernels (hence the tuples) selected at the previous iteration and performing the linear combination of these kernels with the elementary kernels associated with the tuples of S⁽ⁿ⁾. Here again, only the tuples having obtained the highest MKL weights are kept. At the last step of this procedure, the linear combination of kernels obtained corresponds to a set of discriminant tuples, of different orders.

### Performances Obtained by the Approach According to the Invention

FIG. 9 illustrates the performances of the invention as a function of different strategies of selection of the tuples and of size of the codebook:
for a selection of tuples according to a strategy implementing an algorithm of the Multiple Kernel Learning MKL type applied to linear combinations of tuples (“MKL Selection”);
for a selection of tuples according to a geometric strategy based on a Variance Maximization Criterion VMC (“VMC Selection”);
for a selection of 30 tuples chosen randomly (“Random Selection”);
with the exclusive use of only tuples of order 1 (“S⁽¹⁾”), i.e. based on the only points of interest, without combining these latter into pairs, triplets or quadruplets, etc.;
with a single structure consisted of twelve points of interest, i.e. a single tuple of order 12 (“S⁽¹²⁾”), which corresponds to a global analysis of the points of interest considered together as a single set.

The results are given as a function of the size of the codebook, and it can be seen that the optimal performances are reached for a codebook of 256 codewords, and that these results are notably higher than an arbitrary selection of tuples, than an analysis of the only points of interest or than a single kernel corresponding to a simple concatenation of the descriptors of all the points of interest.

Finally, FIG. 10 shows the distribution, as a function of their order n, of the tuples S⁽ⁿ⁾ kept at the end of the procedure of selection of the most relevant tuples. It can be seen that this distribution, which, in the example illustrated, corresponds to the twenty selected tuples having obtained the best weight β attributed by the MKL weighting, is strongly centered about orders n=2 and 3. This clearly shows that the most discriminant structured characteristics correspond to the tuples of S⁽²⁾ and S⁽³⁾, i.e. to the pairs and the triplets of points of interest.

1. A method for automatic language recognition by analysis of the visual voice activity of a video sequence comprising a succession of images of the mouth region of a speaker, by following-up the local deformations of a set of predetermined points of interest selected on this mouth region of the speaker,
the method being characterized in that it comprises the following steps:
a) for each point of interest (10) of each image, calculating (22):
a local gradient descriptor, function of an estimation of the distribution of the oriented gradients, and
a local movement descriptor, function of an estimation of the oriented optical flows between successive images,
said descriptors being calculated between successive images in the vicinity of the considered point of interest;
b) forming (22) microstructures of n points of interest, each defined by a tuple of order n, with n≧1;
c) determining (22), for each tuple of step b), a vector of structured visual characteristics encoding the local deformations as well the spatial relation between the underlying points of interest, this vector being formed based on said local gradient and movement descriptors of the points of interest of the tuple;
d) for each tuple, mapping (24) the vector determined at step c) into a corresponding codeword, by application of a classification algorithm adapted to select a single codeword among a finite set of codewords (CW) forming a codebook (CB);
e) generating an ordered time series (a₀ . . . a₃ . . . ) of the codewords determined at step d) for each tuple, for the successive images of the video sequence;
f) for each tuple, analyzing the time series of codewords generated at step e), by measuring the similarity (26) with another time series of codewords coming from another speaker.

2. The method of claim 1, wherein the measurement of similarity of step f) is implemented by a function of the String Kernel type, adapted to:
f1) recognize matching sub-sequences of codewords of predetermined size (g) present in the generated time series (Xₛ) and in the other time series (X′ₛ), respectively, a potential discordance of a predetermined size (m) being tolerated, and
f2) calculate the rates of occurrence of said sub-sequences of codewords, so as to map, for each tuple, the time series of codewords into fixed-length representations of string kernels.

3. The method of claim 1, wherein the local gradient descriptor is a descriptor of the Histogram of the Oriented Gradients HOG type.

4. The method of claim 1, wherein the local movement descriptor is a descriptor of the Histogram of the Optical Flows HOF type.

5. The method of claim 1, wherein the classification algorithm of step d) is a non-supervised classification algorithm of the k-means algorithm type.

6. The method of claim 1, further comprising a step of:
g) using the results of the measurement of similarity of step f) for a learning (28) by a supervised classification algorithm of the Support Vector Machine SVM type.
